(19) United States
(12) Patent Application Publication
(10) Pub. No.: US 2019/0279086 A1
(43) Pub. Date: Sep. 12, 2019

(54) DATA FLOW GRAPH NODE UPDATE FOR MACHINE LEARNING

(71) Applicant: Wave Computing, Inc., Campbell, CA (US)

(72) Inventors: Christopher John Nicol, Campbell, CA (US); Lin Zhong, San Jose, CA (US)

(21) Appl. No.: 16/423,051

(22) Filed: May 27, 2019

Related U.S. Application Data
(63) Continuation-in-part of application No. 16/104,586, filed on Aug. 17, 2018.
(60) Provisional application No. 62/827,333, filed on Apr. 1, 2019.
(60) Provisional application No. 62/802,307, filed on Feb. 7, 2019.
(60) Provisional application No. 62/800,432, filed on Feb. 2, 2019.
(60) Provisional application No. 62/773,486, filed on Nov. 30, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/547,769, filed on Aug. 19, 2017.

(51) Int. Cl. G06N 3/08; G06N 3/04

(52) U.S. Cl. CPC G06N 3/08; G06N 3/04

(57) ABSTRACT

Techniques are disclosed for data flow graph node update for machine learning. A plurality of processing elements is configured within a reconfigurable fabric to implement a data flow graph. The nodes of the data flow graph include one or more variable nodes, and the data flow graph implements a neural network. N copies of a variable contained in a variable node are issued, where the N copies are used for distribution within the data flow graph, and where N is an integer greater than or equal to one and less than or equal to the total number of nodes in the graph. The N copies of a variable are distributed within the data flow graph. The neural network is updated based on the N copies of a variable. Results from the distribution are averaged. The averaging includes parallel training of different data for machine learning.

### RELATED APPLICATIONS

This application claims the benefit of U.S. provisional patent applications “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, “Reconfigurable Fabric Configuration Using Spatial and Temporal Routing” Ser. No. 62/773,486, filed Nov. 30, 2018, “Machine Learning for Voice Calls Using a Neural Network on a Reconfigurable Fabric” Ser. No. 62/800,432, filed Feb. 2, 2019, “FIFO Filling Logic for Tensor Calculation” Ser. No. 62/802,307, filed Feb. 7, 2019, and “Matrix Multiplication Engine Using Pipelining” Ser. No. 62/827,333, filed Apr. 1, 2019.

This application is also a continuation-in-part of “Reconfigurable Fabric Data Routing” Ser. No. 16/104,586, filed Aug. 17, 2018, which claims the benefit of U.S. provisional patent applications “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to data flow graph node update for machine learning.

### BACKGROUND

Researchers, businesspeople, and governments collect and analyze vast amounts of data. The data is most typically collected from people as they interact with their personal and other electronic devices. The interactions can be online, in public, or at home. The collection of public, personal, and other data has become so commonplace that the collection frequently goes unnoticed until there is a problem. An individual may be using her smartphone to research world events, while another person is using his tablet to order pet food or toner cartridges. Irrespective of the particular activity, metadata is collected about the user interactions with their devices. Data and metadata include details such as websites visited, products and services searched or viewed, and radio buttons clicked. All of this data is collected and analyzed for purposes of monetization, security, or surveillance, among others. Analysis results are used to push online content, products, or services that are predicted to match user interests.

Emerging software analysis techniques and processor architectures are propelling the collection of personal and other data at an accelerating rate. Businesspeople, researchers, and governments aggregate the collected data into datasets that are often referred to as “big data”. The big data datasets can then be analyzed. The sizes of the big data datasets overwhelm the capabilities of the traditional processors and analysis techniques, making the analysis economically infeasible. Other data handling requirements, such as the access, capture, maintenance, storage, transmission, and visualization of the data, among other tasks, further complicate the computational and processing requirements. Any one of these data handling requirements can quickly saturate or exceed the capacities of the traditional systems. The collected data would be of little or no fundamental value without viable and scalable data analysis and handling techniques. Innovative computing architectures, plus software techniques, algorithms, functions, routines, and heuristics, are necessitated. Dataset stakeholders are motivated by business, research, and other interests to analyze the data. Common data analysis purposes include business analysis; disease or infection detection, tracking, and control; crime detection and prevention; meteorology; and complex scientific and engineering simulations; among many others. Advanced data analysis techniques are finding applications such as predictive analytics, which can be used to show consumers what they want, even before the consumers know that they want it. Further approaches include applying machine learning and deep learning techniques in support of the data analysis.

Advanced processing hardware has been introduced, as have software learning techniques, which have been a boon to many computer science disciplines including machine learning. Machine learning posits that a machine on its own can “learn” about a unique dataset. The machine learning occurs without the machine having to be explicitly coded or programmed by a user to handle that dataset. Machine learning can be performed on a network of processors such as a neural network. The neural network can process the big data datasets so that the neural network can learn about the data contained within the dataset. The greater the quantity of data, and the higher the quality of the data that is processed, the better the outcome of the machine learning. The processors on which the machine learning techniques can be executed are designed to efficiently handle the flow of data. These processors, which are based on data flow architectures, process data when valid data is presented to the processor. Data flow architectures enable simplifications to a processing system such as avoiding a need for a global system clock.

Computing architectures based on reconfigurable hardware are highly flexible and are particularly well suited to processing large data sets, performing complex computations, and executing other computationally resource-intensive applications. Reconfigurable computing integrates the key advantages drawn from hardware and software techniques. A reconfigurable computing architecture can be “recoded” (reprogrammed) to suit a processing need. The recoding adapts or configures the high-performance hardware architecture, much like recoding software. A reconfigurable fabric hardware technique is directly applicable to reconfigurable computing. Reconfigurable fabrics may be arranged in topologies or configurations for the many applications that require high performance computing. Applications such as processing of big data, digital signal processing (DSP), machine learning based on neural networks, matrix or tensor computations, vector operations, or Boolean manipulations, and so on, can be implemented within a reconfigurable fabric. The reconfigurable fabric fares particularly well when the data includes specific types of data, large quantities of unstructured data, sample data, training data, and the like. The reconfigurable fabrics can be coded or scheduled to achieve these and other processing techniques, and to represent a variety of efficient computer architectures.

### SUMMARY

A data flow graph includes nodes that represent operations to be performed on data and arcs that represent the flow of data between and among the nodes. A data flow graph is particularly well suited to understanding a variety of highly complex computing tasks and to representing the calculations and flow of data required to perform those tasks. One computational example that can be represented using data flow graphs is machine learning. Machine learning is a technique by which a computing system, such as a reconfigurable fabric, can be configured to “learn”. That is, the computing system adapts itself, as it processes data, to improve inferences, computational performance, and so on. Machine learning systems can be based on neural networks such as convolutional neural networks (CNN), deep neural networks, (DNN), a recurrent neural network (RNN), and so on.

A reconfigurable fabric can be configured or “coded” to implement a given data flow graph. A reconfigurable fabric can also be adapted or “recoded” to implement a given data flow graph. The data flow graph itself can be adapted by changing code used to configure elements of the reconfigurable fabric, parameters or values such as weights, scales, or biases processed by the data flow graph, etc. The reconfigurable fabric can include computational or processor elements, storage elements, switching elements for data transfer, control elements, and so on. The reconfigurable fabrics are coded to implement a variety of processing topologies for machine learning. The reconfigurable fabric can be configured by coding or scheduling the reconfigurable fabric to execute a variety of logical operations such as Boolean operations, matrix operations, tensor operations, mathematical operations, etc. The scheduling of the reconfigurable fabric can be changed based on a data flow graph.

Data flow graph node updates are performed for machine learning. Embodiments include a processor-implemented method for data manipulation comprising: configuring a plurality of processing elements within a reconfigurable fabric to implement a data flow graph, wherein the nodes of the data flow graph include one or more variable nodes, and wherein the data flow graph implements a neural network; issuing N copies of a variable contained in one of the one or more variable nodes, wherein the N copies are used for distribution within the data flow graph, and wherein N is an integer greater than or equal to 1 and less than or equal to the total number of nodes in the graph; distributing the N copies of a variable within the data flow graph; and updating the neural network, based on the N copies of a variable. In embodiments, the issuing N copies occurs before the one or more variable nodes are paused for updating. In embodiments, the distributing within the data flow graph includes propagating the N copies to other nodes within the data flow graph. In other embodiments, the other nodes include non-variable nodes. And in still other embodiments, the non-variable nodes further distribute the N copies to still other nodes within the data flow graph.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for data flow graph node update for machine learning.

FIG. 2 is a flow diagram for pausing a data flow graph.

FIG. 3 shows distribution of N copies within a data flow graph.

FIG. 4 shows a network for a data flow graph.

FIG. 5 illustrates a deep learning program graph.

FIG. 6 shows an assembled data flow graph for runtime.

FIG. 7 illustrates batch processing for training.

FIG. 8 shows execution manager operation.

FIG. 9 shows a cluster for coarse-grained reconfigurable processing.

FIG. 10 shows a block diagram of a circular buffer.

FIG. 11 illustrates circular buffers and processing elements.

FIG. 12 shows a deep learning block diagram.

FIG. 13 is a system for a data flow graph update for machine learning.

### DETAILED DESCRIPTION

Techniques for data flow graph node update for machine learning are disclosed. Data flow graph node updates can be performed on a computing device, a reconfigurable computing device, an integrated circuit or chip, and so on. A reconfigurable fabric is an example of a reconfigurable computing device that incorporates critical features of both hardware techniques and software techniques. The hardware techniques include computer architectures carefully designed for high performance computations. The included software techniques enable the hardware to be reconfigured easily for specific computational tasks such as processing data flow graphs, performing machine learning, and so on. A reconfigurable fabric can include one or more element types, where the element types can include processing elements, storage elements, switching elements, and so on. An element can be configured to perform a variety of architectural and computational operations, based on the type of element, by programming, coding, or “scheduling” the element. The reconfigurable fabric can include quads of elements, where the quads include processing elements, shared storage elements, switching elements, circular buffers for control, communications paths, registers, and the like. An element or subset of elements within the reconfigurable fabric, such as a quad of elements, can be controlled by providing code to one or more circular buffers. The code can be executed by enabling—or configuring—the circular buffers to rotate. Code can also be provided to elements within the reconfigurable fabric so that the reconfigurable fabric can perform intended computational tasks such as logical operations including Boolean operations, matrix computations, tensor operations, mathematical operations, machine learning operations, etc. The various elements of the reconfigurable fabric can be controlled by the rotating circular buffers, where the one or more circular buffers can be of the same length or differing lengths. Functions, routines, algorithms, instructions, codes, etc., can be loaded into a given circular buffer. The rotation of the given circular buffer ensures that the same series of coded steps or instructions is repeated as required by the processing tasks assigned to a processing element of the reconfigurable fabric. The one or more rotating circular buffers can be statically scheduled.

Machine learning uses data flow graph node updates. A data flow graph includes nodes that perform computations and arcs that indicate the flow of data between and among the various nodes. A plurality of processing elements is configured within a reconfigurable fabric to implement a data flow graph. The reconfigurable fabric can include other elements such as storage elements, switching elements, or communications paths. The nodes of the data flow graph include one or more variable nodes. The variable nodes can include data, training data, biases, and so on. The data flow graph can implement a neural network such as a deep learning network (DNN), a convolutional neural network (CNN), a recurrent neural network (RUN), etc. The variable nodes can include weights for a neural network such as a deep learning network. N copies are issued of a variable contained in one of the one or more variable nodes. The variable nodes can include weights for the neural network, biases, and so on. The N copies are used for distribution within the data flow graph. The distribution within the data flow graph can include propagating the N copies to other nodes within the data flow graph. N is an integer greater than or equal to 1 and less than or equal to the total number of nodes in the graph. The N copies of a variable are distributed within the data flow graph. The distribution within the data flow graph includes propagating the N copies to other nodes within the data flow graph. The other nodes can include non-variable nodes, where the non-variable nodes further distribute the N copies to still other nodes within the data flow graph. The neural network is updated based on the N copies of a variable. The updates resulting from the distributing the N copies of a variable can be averaged. The averaging can include a running average.

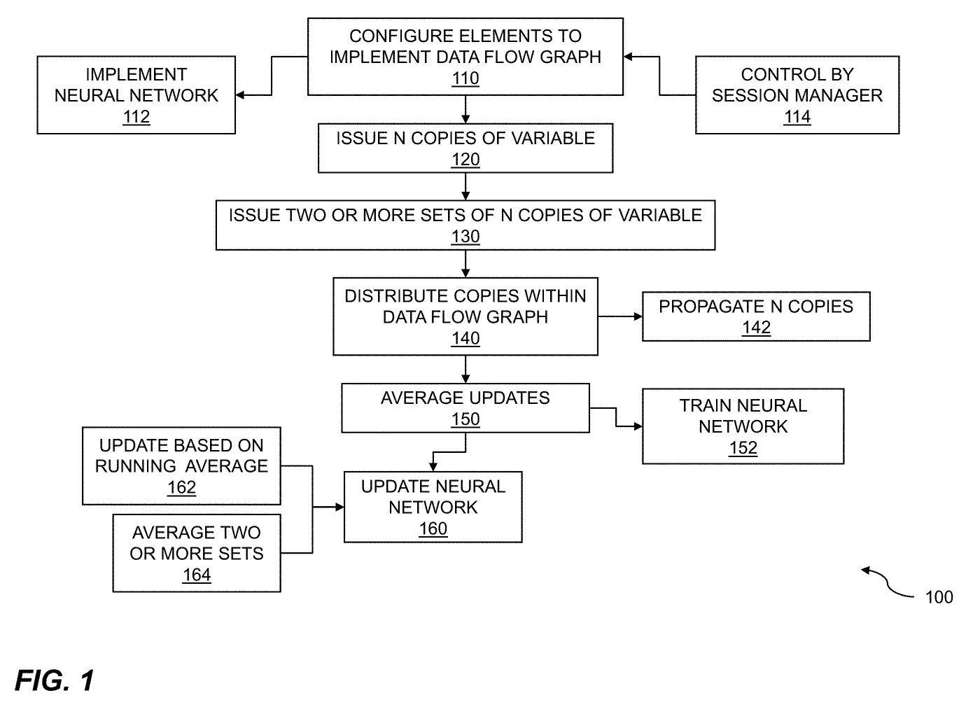

FIG. 1 is a flow diagram for a data flow graph node update for machine learning. The flow 100 includes configuring a plurality of processing elements within a reconfigurable fabric to implement a data flow graph 110. The data flow graph includes nodes and arcs, where the nodes can correspond to operations, and the arcs can correspond to flows of data. In embodiments, the nodes of the data flow graph include one or more variable nodes. Parameters of the variable nodes can be adjusted, where the adjusting can be performed to improve data flow graph performance, convergence, and so on. In embodiments, the variable nodes contain weights for deep learning, where the weights for deep learning can be adjusted. The reconfigurable fabric can include clusters of processing elements, where the clusters of processing elements can include quads of processing elements. The reconfigurable fabric can include other types of elements such as storage elements, switching elements, and so on. In embodiments, the processing elements can be controlled by circular buffers. The circular buffers can include rotating circular buffers. The configuring of the processing elements can be accomplished by scheduling or loading commands, instructions, code, etc., into the circular buffers. The circular buffers can be statically scheduled. In embodiments, the data flow graph implements a neural network 112. The neural network implemented by the data flow graph can include deep learning or machine learning, where the deep learning or machine learning can be performed by a deep learning network. The data flow graph can include machine learning. In embodiments, the data flow graph can be used to train a neural network. The data flow graph can represent a neural network such as a deep neural network (DNN), a convolutional neural network (CNN), and the like. In other embodiments, the neural network can include a recurrent neural network (RNN). The configuring the plurality of processing elements can be controlled by a session manager 114. The session manager can choose a data flow graph for execution, partition the data flow graph, schedule execution of the data flow graph on the reconfigurable fabric, and so on.

The flow 100 includes issuing N copies of a variable 120 contained in one of the one or more variable nodes. The variables can contain include Boolean values, matrix values, tensor values, and the like. The variables can contain weights for a neural network, where the neural network can include a deep learning network, a machine learning network, and so on. The N copies that can be issued can be used for distribution within the data flow graph. The N copies can be distributed to some or all nodes within the data flow graph. In embodiments, N is an integer greater than or equal to 1 and less than or equal to the total number of nodes in the graph such as a data flow graph. The flow 100 includes issuing two or more sets of N copies of the variable 130 for distribution within the data flow graph. By issuing sets of N copies of the variable, the copies can be efficiently distributed in parallel to nodes of the data flow graph. The two or more sets of N copies of the variable can be written into storage then referenced using a pointer.

The flow 100 includes distributing the N copies of a variable within the data flow graph 140. In some cases, N can be higher than the number of nodes within the data flow graph. The distributing the N copies of the variable can be accomplished by writing the copies of the variables to storage associated with nodes of the data flow graph, passing a pointer, and so on. The storage can include storage within the reconfigurable fabric, storage beyond the reconfigurable fabric, and so on. The storage beyond the reconfigurable fabric can be accessed using a direct memory access (DMA) technique. Not all of the nodes need be variable nodes of the data flow graph. In embodiments, the other nodes to which the N copies can be distributed can include non-variable nodes. The non-variable nodes can include biases, scales, factors, and other values that can be used by the data flow graph. The non-variable nodes can be used for store-and-forward data transfer techniques. In embodiments, the non-variable nodes further distribute the N copies to still other nodes within the data flow graph. The distribution of the N copies of the variable can resemble a “wave” of variables moving across the data flow graph. In embodiments, the distribution within the data flow graph includes propagating the N copies 142 to other nodes within the data flow graph. In embodiments, the data flow graph comprises pipelining and the N copies can be used within one or more pipelines. In some embodiments, multiple variables are copied within the data flow graph.

The flow 100 includes averaging updates 150 resulting from the distributing the N copies of a variable. The N copies of the variable can be processed by the one or more nodes of the data flow graph to which the copies were distributed. The results or “updates” can be used to adjust weights, factors, scales, biases, etc., of a network such as a neural network. The data flow graph can be used to train a neural network 152. Embodiments further include training the neural network, based on the averaging. The training can include back-propagation of updates, forward-propagation of updates, etc. The updates can be used to learn or adjust weights of the neural network, to learn layers of the neural network, etc. In embodiments, the training can include distributed neural network training. Since the updates can be distributed to multiple nodes, layers, etc., of the neural network, training of the nodes, layers, and so on can be performed in parallel. The flow 100 includes updating the neural network 160. The updating of the neural network can include further training of the neural network, where the further training can be accomplished by applying additional training data to the neural network, by applying further updates, and so on. The flow 100 further includes updating based on a running average 162 of copies of the variable with the data flow graph. The running average of copies of the variable can be computed as updates arrive, after a quantity of updates has arrived, and so on. Embodiments further include averaging two or more sets 164 of updates resulting from the distributing the two or more sets of N copies. A greater number of sets of updates that are averaged can result in improved training of the neural network, faster convergence by the neural network, and so on. In embodiments the averaging two or more sets of updates can include parallel training of different data for machine learning. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

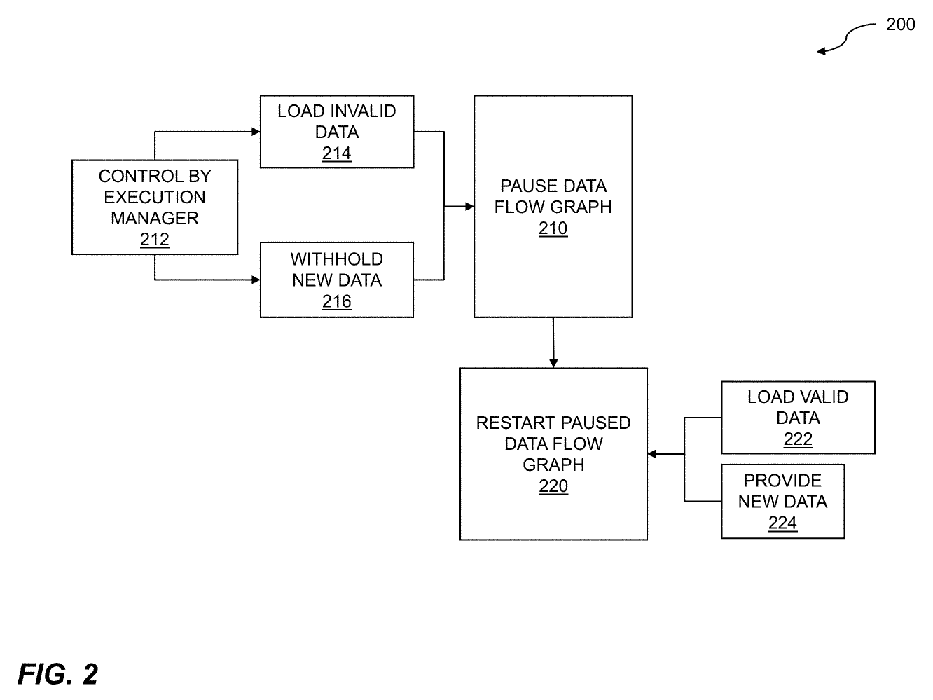

FIG. 2 is a flow diagram for pausing a data flow graph. A data flow graph can be used to represent processing of data as the data flows among nodes of the graph. The nodes, which can be represented by agents, processing elements, and so on, can perform a variety of computations such as logical operations, matrix manipulations, tensor operations, Boolean operations, mathematical computations, and so on. Data flow graph node updates can be performed for machine learning. The data flow node update can be performed within a reconfigurable fabric. A plurality of processing elements within a reconfigurable fabric is configured to implement a data flow graph. N copies of a variable contained in one of the one or more variable nodes are issued. The N copies are used for distribution within the data flow graph. The N copies of a variable are distributed within the data flow graph, and the neural network is updated based on the N copies of a variable. Computation by the nodes of the data flow graph within the reconfigurable fabric can be paused and restarted.

The flow 200 includes pausing the data flow graph 210. The pausing the data flow graph can result from a variety of conditions, statuses, etc. Note that to execute a data flow graph, the data flow graph may be partitioned into subgraphs. The data flow graph can be paused if there is a need to execute a higher priority agent or subgraph, if an amount of time such as processing time has elapsed, and so on. In embodiments, the pausing is controlled by an execution manager 212. The execution manager can control processing and monitoring of control signals such as fire and done signals. The execution manager can control the flow of data among the nodes of the data flow graph. In embodiments, the pausing can be accomplished by loading invalid data 214. The invalid data can include ill-formed numbers, matrices with zero rows and zero columns, special characters, reserved values, invalid pointers, and so on. In other embodiments, the pausing can be accomplished by withholding new data 216 from entering the data flow graph. Recall that a data flow processor operates on data when the data is available to the processor. If there is no data available to the processor, then the processor is “starved” and can suspend operation.

A data flow graph can be paused and restarted at a later time. For the data flow graph to successfully resume processing, the state of the data flow graph at the time the data flow graph was paused can be stored and restored. The state of the data flow graph can include control signals, data, and so on. The state of the paused data flow graph can be restored prior to restarting the data flow graph. The flow 200 includes restarting a paused data flow graph 220. The restarting of the paused data flow graph can include loading nodes of the data flow graph back onto a reconfigurable fabric or other computing device. The restarting a paused data flow graph can be accomplished by loading a set of checkpointed buffers. Note that when a data flow graph was paused, the buffers associated with the nodes of the data flow graph can be checkpointed. The buffers can be loaded with the checkpointed information, where the checkpointed information can include input data, output data, fire and done signal statuses, and the like. The restarting can include issuing a run command, for example, to each node within the data flow graph. The run command can be issued by the execution manager, by a signal manager, and so on. The run command can include one or more fire signals. In embodiments, the restarting can include providing new data 224 to the starting node. Since the data flow graph executes when valid data is present and ready for processing, loading valid data 222 to an input node or starting node can cause the data flow graph to resume execution. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

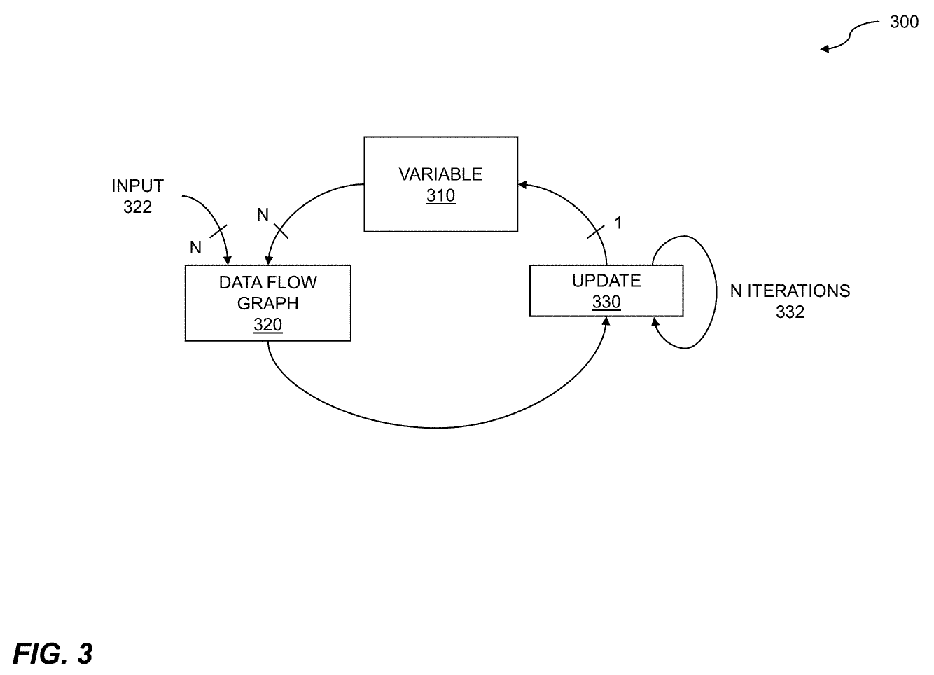

FIG. 3 shows distribution of N copies within a data flow graph. Multiple copies of a variable can be distributed within a data flow graph where the data flow graph can include a neural network, a deep learning network, a machine learning network, and so on. The copies of the variable can be distributed to nodes of the data flow graph, where the variable can be updated. The updates of the variable that can be updated can be averaged, scaled, compressed, normalized, and so on, for various purposes such as training a deep learning network. The distribution of N copies 300 of a variable within a data flow graph supports data flow graph node update for machine learning. A variable 310 can be copied N times, where N can be an integer greater than or equal to 1 and can be less than or equal to the total number of nodes in the data flow graph. The N copies of the variable can be issued to and distributed within the nodes of the data flow graph 320. N copies of inputs 322, where the inputs can include data, training data, and so on, may also be issued to and distributed within the nodes of the data flow graph. The nodes of the data flow graph, where the nodes of the data flow graph can represent neurons, layers, and so on, of a neural network, can compute updates 330. Updates can be accumulated, captured, or otherwise obtained from the nodes of the data flow graph. Updating can include forward-propagation of values within the data flow graph, back-propagation of values with the data flow graph, and the like. The updates can be captured based on iterations such as N iterations 332, averaging, reducing, scaling, compressing, and so on. In embodiments, the averaging, for example, can include averaging two or more sets of updates resulting from the distributing the two or more sets of N copies of the variable. The averaging can include a running average. The results of the updating can be used to update the variable 310. The updated variable 310 can then be copied N times, reissued, and redistributed to the data flow graph.

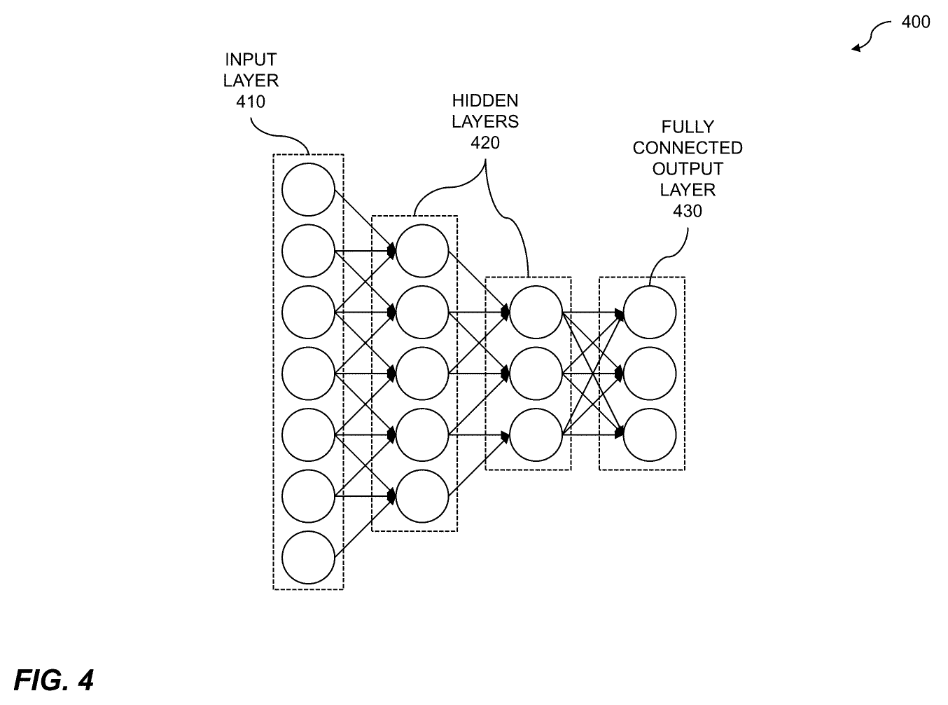

FIG. 4 shows a network for a data flow graph. A network can include various portions such as interconnects, communication channels, processing elements, storage elements, switching elements, and so on. A network can be implemented using one or more computing devices, a computational device, one or more processors, a reconfigurable fabric of processing elements, and the like. A network for executing a data flow graph can be assembled. A data flow graph is a representation of how various types of data, such as image data, training data, matrices, tensors, and so on, flows through a computational system. A data flow graph includes nodes and arcs, where the nodes represent operations on data, and the arcs represent the flow of data between and among nodes. The operations of the nodes can be implemented using agents. The data flow graph can be implemented on the network by assigning processing elements, storage elements, switching elements, etc. to nodes or agents and to arcs of the data flow graph. The network can support data flow graph node update for machine learning.

A network 400 is shown. The network includes layers, where the layers can include an input layer 410, an output layer, such as a fully connected output layer 430, and one or more hidden layers 420. The layers of the network can include one or more bottleneck layers. The network can include a deep neural network (DNN), a convolutional neural network (CNN), and so on. The network can implement a machine learning system. The input layer 410 can receive input data, where the input data can include sample data, test data, image data, audio data, matrices, tensors, and so on. The input layer can receive other data such as weights. The nodes of the input layer can perform an operation on the data, where the operation can include a multiplication, an addition, an accumulation (A=A+B), and so on. The input layer can be connected to one or more hidden layers 420. The hidden layers can perform a variety of operations on the input data and on other data such as bias values. The hidden layers can include one or more bottleneck layers. The bottleneck layer can include a layer that has fewer nodes than the one or more preceding hidden layers. The bottleneck layer can create a constriction within the network. The bottleneck layer can force information that is pertinent to an inference, for example, into a lower dimensional representation. The one or more hidden layers can be connected to an output layer. In the example 400, the output layer can be a fully connected layer 430. In a fully connected layer, each node, agent, or neuron in a layer such as the output layer is coupled to each node of another layer. In the case of an output layer, each node of the output layer is coupled to each node of a preceding hidden layer. A fully connected layer can improve classification of data by examining all of the data in a previous layer rather than examining just a subset of the data. An equivalent convolutional layer can represent a fully connected layer. For computational reasons, a convolutional layer may be used in place of a fully connected layer.

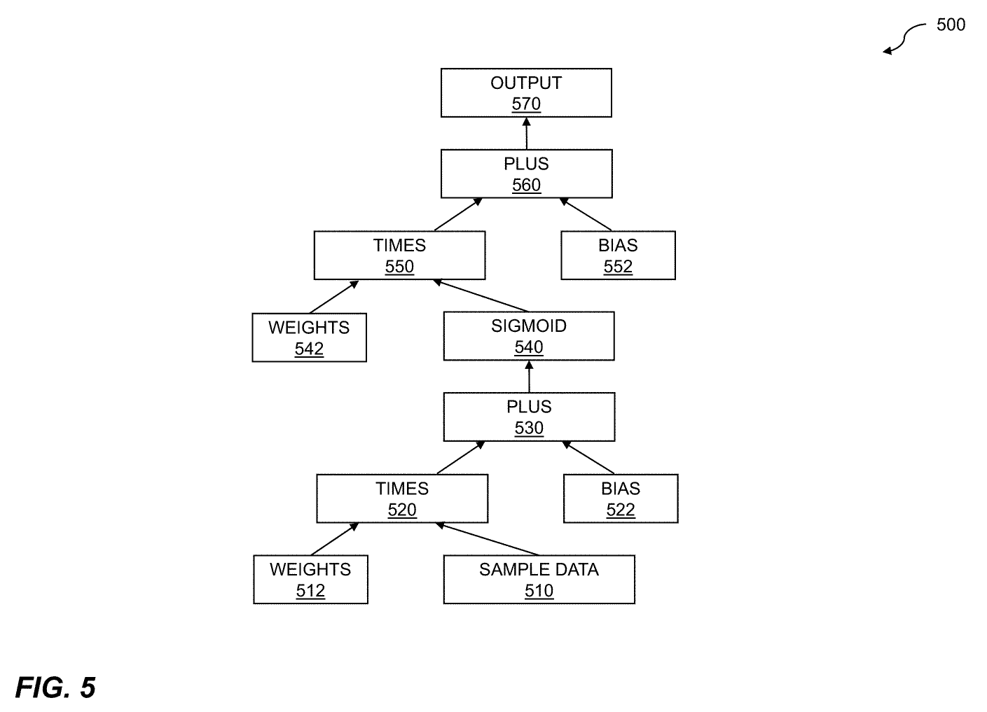

FIG. 5 illustrates a deep learning program graph. A program graph can be a computational representation of a data flow graph. The deep learning program graph can show operations and data flow for a data flow graph node update for machine learning. A program graph can show both the logical operations to be performed on data and the flow of data between and among the logical operations. The program graph can show inputs, where the inputs can collect various types of data. The data can include test data, sample data, weights, biases, and so on. The program graph can show logical operations, where the logical operations can include Boolean operations, matrix operations, tensor operations, mathematical operations, and the like.

A deep learning (DL) program graph is shown 500. The deep learning program graph can include inputs and computational nodes. The inputs to the DL graph can include sample data 510 or test data, weights 512, and so on. The input data can include matrices, tensors, data files of images, and so on. The inputs can be operated on by a computation node. The computation node 520 can perform a multiplication of the weights 512 and the sample data 510. Other computational nodes can be included in the deep learning program graph. An addition node plus 530 can calculate a sum of the products or the partial products from times 520 and bias values 522. The bias values can be used to enhance performance of a deep neural network, such as a DL network, by improving convergence, improving inferences, etc. The one or more sums from the plus node 530 can be processed by a sigmoid node 540. A sigmoid node 540 can be used to perform an activation function such as a rectified linear unit (ReLU) operation, a hyperbolic tangent (tan h) operation, and so on. A further computation node 550 can perform a multiplication operation, times 550. The times operation can multiply the results of processing data with the sigmoid function by weights 542. A further computation node plus 560 can compute the sum of the products or the partial products from times 550 and bias values 552. The sums computed by plus 560 can be routed to an output node such as output node 570. Data can be collected from the output node for various purposes such as storage, processing by a further program graph, and so on.

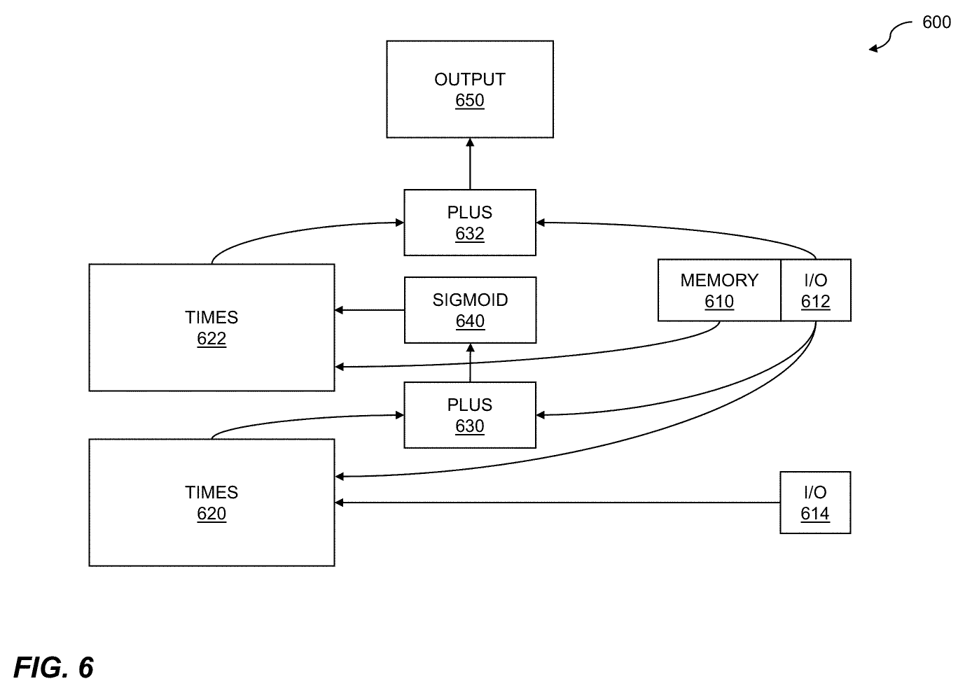

FIG. 6 shows an assembled data flow graph for runtime 600. In its most general sense, a data flow graph is an abstract construct which can describe the flow of data from one or more input nodes, through processing nodes, to one or more output nodes. The processing nodes describe operations such as logical operations, matrix operations, tensor operations, Boolean operations, etc., that can be performed on that data. The processing operations of the nodes can be performed by agents. To execute the data flow graph, the data flow graph can be assembled at runtime. The assembly can include configuring data input/output, memory input/output, and so on. The assembled data flow graph can be executed on the data flow processor. The execution of the assembled data flow graph supports data flow graph node updates for machine learning.

The techniques for assembling the data flow graph for runtime can be analogous to classic compilation of code. The steps of compilation of code can include preprocessing, compiling, assembling, linking, and so on. Inputs and outputs can be assigned to input/output ports of a computing device, a reconfigurable fabric, etc.; buffers can be assigned to store, retime, or buffer data; agents can be assigned to processing elements; etc. The result of the linking can include an “execution module” or executable code that can be executed on a computing device. The executable code of the assembled data flow graph for runtime can be assigned to clusters of processing elements within the reconfigurable fabric. Processing elements of the reconfigurable fabric can be configured to implement the agents of the data flow graph by statically scheduling rotating circular buffers, where the rotating circular buffers can control the operation of the processing elements. A set of buffers can be initialized for an agent. The buffers can be located within or beyond the reconfigurable fabric.

An assembled data flow graph for runtime is shown. The assembled data flow graph can include memory 610 for storing data, intermediate results, weights, etc., input/output ports 612, and further input/output ports 614. The input/output ports can include assigned input/output ports of the reconfigurable fabric, communications paths through the fabric, and the like. The input/output ports can receive learning data, raw data, weights, biases, etc., and can send computation results, inferences, back-propagated weights, etc. The assembled data flow graph can include multiplication agents, such as a first times agent 620 and an additional times agent 622. The first times agent 620 can multiply sample data or test data by weights, the second times agent 622 can multiply weights by a sigmoid function 640, and so on. The assembled data flow graph can further include addition agents, such as a first plus agent 630 and second plus agent 632. The plus agent 630 can add partial products or products from times agent 620 to bias values. The plus agent 632 can add partial products or products from times agent 622 with bias values. The sums, partial sums, etc., that can be calculated by the plus agent 632 can be output 650. The output can include computational results, inferences, weights, and so on.

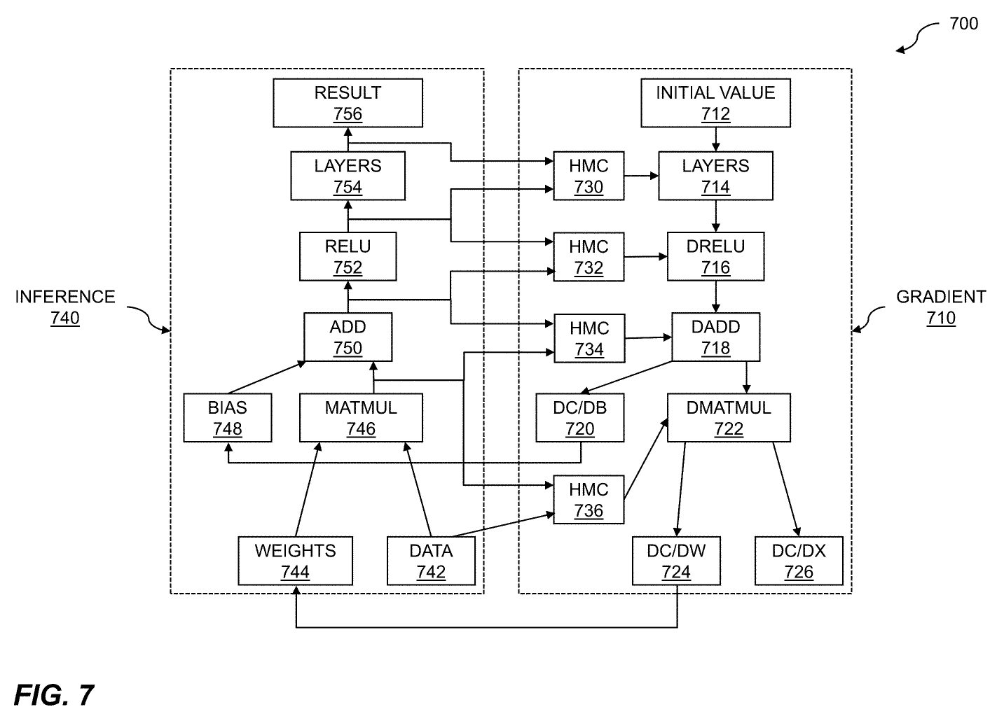

FIG. 7 illustrates batch processing for training. As discussed throughout, a data flow graph can represent a deep learning network. The deep learning network can be trained autonomously using a data flow graph node update for machine learning. The training of a deep neural network (DNN) for deep learning (DL) can be an iterative process in which data from a large dataset is applied to the DNN. The data in the large dataset can be preprocessed in order to improve training of the DNN. The DNN attempts to form inferences about the data, and errors associated with the inferences can be determined. Through various techniques such as back propagation and gradient-based analysis, weights of the DNN can be updated with an adjusted weight which can be proportional to an error function.

Training of a data flow graph for deep learning is shown 700. The deep learning network can include a gradient side 710 and an inference side 740. The gradient side can be used to perform gradient descent or other techniques for error analysis which can facilitate the determining of weights and adjustments to weights for the deep learning network. An initial value 712 can be provided at an input node of the gradient side. The initial value can be processed by layers 714 of the deep learning network, where the layers can include an input layer, hidden layers, an output layer, etc. Data such as error data from the inference side can be fed back to the gradient side by storing the data in a hybrid memory cube (HMC) 730. The data in the HMC can be fed into the layers 714 for reducing inference error. The network can include one or more differential rectified linear units (dReLU) 716. The dReLU can execute an activation function on data received from the layers and from an HMC 732. Data can be applied to a differential addition dAdd operation 718. The dAdd operation data can also include data that can be fed back from the inference portion of the deep learning network. Data such as error data from the inference portion of the DLN can be stored in HMC 734, and the dAdd operation can process that data. An output such as dC/dB 720 can be calculated, where C can indicate a differential result, and B can indicate a bias, and where the bias can enhance DNN operation. The bias can be used to enable neurons of the DNN to fire as desired even for data values near or equal to zero. The gradient portion of the DLN can include a differential matrix multiplication (dMatMul) 722 operation. The dMatMul operation can process data output from the dAdd operation and data stored in HMC 736. The data stored in the HMC can include results from an operation such as a matrix multiplication operation, training data, and so on. The dMatMul operation can generate one or more outputs such as dC/dx 726, where C can indicate a differential result, dC/dW 724, and where W can indicate a differential weight.

The inference side 740 of the DNN can take as inputs data 742 such as training data, weights 744, which can include or be adjusted by the dC/dW values 724, and bias values 748, which can include or be adjusted by dC/dB values 720. The data 742 and weights 744 can be variable nodes within the data flow graph. The weights and the data can be processed by a matrix multiplication (MatMul) operation 746. The results of the MatMul operation can be added with the bias values 748 using an addition operation 750. The results of the addition operation can be processed using an activation function such as a sigmoid function. A sigmoid function can include a rectified linear unit (ReLU) 752 where f(x)=max(0,x), a hyperbolic tangent function, an error function, and so on. The inference side of the DNN can include one or more layers 754, where the layers can include an input layer, an output layer, hidden layers, a bottleneck layer, etc. The output of the DNN layers can include a result 756. The result can include an inference determined for data, training data, and the like and can be based on an error or difference between the calculated result and an anticipated result. The training can continue until a desired level of training error such as a minimum error or target error can be attained.

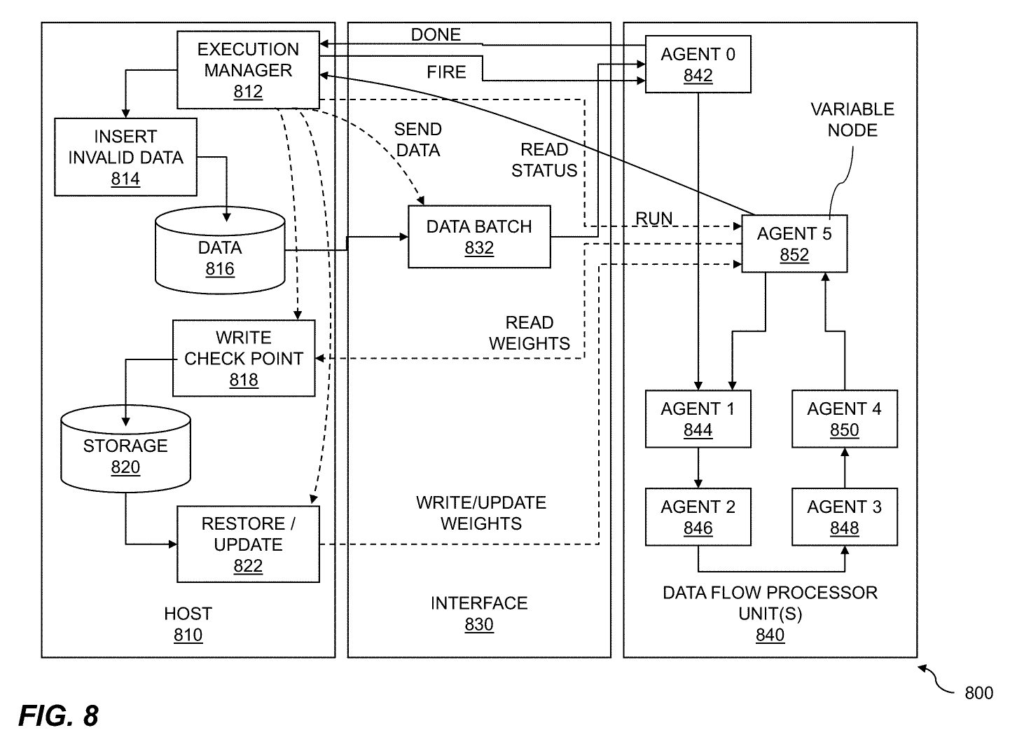

FIG. 8 shows execution manager operation. An execution manager can be associated with a data flow graph. The execution manager can perform a variety of tasks in support of the data flow graph. The tasks that can be performed by the execution manager can include providing data to input agents of the data flow graph, collecting output data from output agents, issuing fire signals to input agents of the data flow graph and receiving done signals from the input agents, sending done signals to the output agents and receiving done signals from the output agents, pausing and restarting data flow graph execution, and so on. The execution manager can enable data flow graph node updates for machine learning.

An example of execution manager operation is shown 800. The execution manager 812 can reside on a host 810, from which it can exert control on the flow of data 816. The host can include a computing device such as a local computer, a remote computer, a cloud-based computer, a distributed computer, a mesh computer, and so on. The computer can run any of a variety of operating systems such as Unix™, Linux™, Windows™, MacOS™, and so on. The control of the data flow by the execution manager can be supported by inserting invalid data 814 into the data 816. When invalid data is detected, execution of the agents in support of the data flow graph can be suspended. Suspending execution of the agents can including halting or suspending the agents and vacating the agents from a reconfigurable fabric which was configured to implement the data flow graph. Since the data flow graph can be reloaded onto the reconfigurable fabric, the states of the agents and the data associated with the agents can be collected. Embodiments include checkpointing a set of buffers for each node within the data flow graph, where the checkpointing is based on a node being paused. Checkpoints that result from the checkpointing can be written 818 into storage 820. The data flow graph that was vacated can be reloaded into the reconfigurable fabric. Further embodiments include restarting a paused data flow graph, wherein the restarting is accomplished by loading a set of checkpointed buffers. The checkpointed buffers can be restored or updated 822 into the reconfigurable fabric.

Execution manager operation can include accessing an interface 830. The interface can include an interface between the host 810 and data flow processor units (DPUs) 840, discussed below. The interface can include a computing device interface such as a peripheral component interconnected express (PCIe or PCI-E) interface. The interface, such as the PCIe interface, can enable transfer of one or more signals such as control signals. The control signals can include fire and done signals for controlling one or more agents; a read weights signal to capture data from agents and buffers associated with agents, such as a variable node or agent, for checkpointing; write and update weights for updating a variable node, a data batch 832 which can include data sent by the execution manager; and so on. Execution manager operation can include one or more data flow processor units 840. The data flow processor units can include one or more reconfigurable fabrics, storage, and so on. The data flow processor units can be configured to implement a data flow graph. Elements or nodes of the data flow graph, such as agents, can be loaded onto the DPUs. The agents can include agent 0 842, which can include an input node, agent 1 844, agent 2 846, agent 3 848, agent 4 850, agent 5 852, and so on. Agent 5 can be a variable node, where a variable node or other nodes can be modified based on machine learning. The variable nodes can contain weights for deep learning. While six agents are shown loaded onto the DPUs, other numbers of agents can be loaded onto the DPUs. The other numbers of agents can be based on the data flow graphs implemented on the DPUs.

In embodiments, variable nodes, such as agent 5 852, can control or regulate the flow of data through a data flow graph, such as in a data flow graph implemented in data flow processor unit(s) 840. A variable node agent can issue N number of multiple copies of a variable for distribution, where N is an integer greater than 1 and less than or equal to the total number of nodes in a data flow graph. The N copies can be issued before the variable node agent stops to wait for an update. The N copies of the variable can be propagated to other agents implemented in other nodes, such as agent 1 844, agent 2 846, agent 3 848, and agent 4 850. Of course, additional agents may reside in additional nodes (not shown). An average of the N updates resulting from the N multiple copies of the variable that were issued can be used for distributed training of a neural network implemented as a data flow graph. In embodiments, two or more sets of N number of copies of the variable can be issued by a variable node and can be in flight in the data flow graph in order to enable two or more averages to be used for parallel training of different data for machine learning.

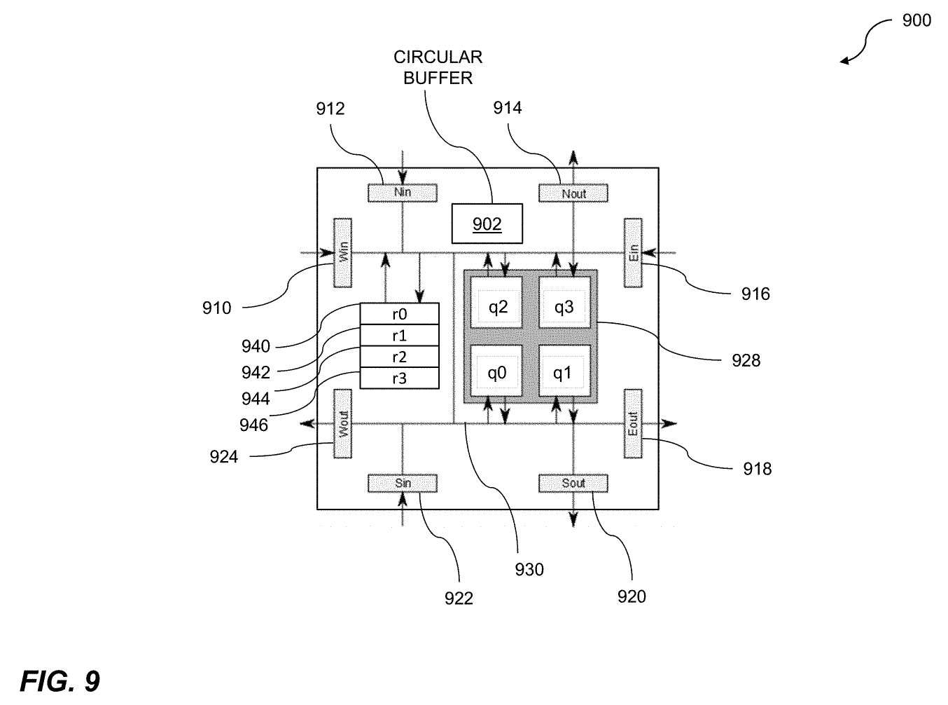

FIG. 9 shows a cluster for coarse-grained reconfigurable processing. The cluster for coarse-grained reconfigurable processing 900 can be used for data flow graph node updates for machine learning. The machine learning can include accessing clusters on a reconfigurable fabric to implement the data flow graph. The processing elements such as clusters of processing elements on the reconfigurable fabric can include processing elements, switching elements, storage elements, etc. The plurality of processing elements can be loaded with a plurality of process agents. A first set of buffers can be initialized for a first process agent, where the first process agent corresponds to a starting node of the data flow graph. The first set of buffers can be loaded with valid data. A fire signal can be issued for the starting node, based on the first set of buffers being initialized.

The cluster 900 comprises a circular buffer 902. The circular buffer 902 can be referred to as a main circular buffer or a switch-instruction circular buffer. In some embodiments, the cluster 900 comprises additional circular buffers corresponding to processing elements within the cluster. The additional circular buffers can be referred to as processor instruction circular buffers. The example cluster 900 comprises a plurality of logical elements, configurable connections between the logical elements, and a circular buffer 902 controlling the configurable connections. The logical elements can further comprise one or more of switching elements, processing elements, or storage elements. The example cluster 900 also comprises four processing elements—q0, q1, q2, and q3. The four processing elements can collectively be referred to as a “quad,” and can be jointly indicated by a grey reference box 928. In embodiments, there is intercommunication among and between each of the four processing elements. In embodiments, the circular buffer 902 controls the passing of data to the quad of processing elements 928 through switching elements. In embodiments, the four processing elements 928 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 900 can further comprise storage elements coupled to the configurable connections. As shown, the cluster 900 comprises four storage elements—r0 940, r1 942, r2 944, and r3 946. The cluster 900 further comprises a north input (Nin) 912, a north output (Nout) 914, an east input (Ein) 916, an east output (Eout) 918, a south input (Sin) 922, a south output (Sout) 920, a west input (Win) 910, and a west output (Wout) 924. The circular buffer 902 can contain switch instructions that implement configurable connections. For example, an instruction effectively connects the west input 910 with the north output 914 and the east output 918 and this routing is accomplished via bus 930. The cluster 900 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 902. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 924 to an instruction placing data on the south output 920, such that the data can be output on both output ports within the same pipeline cycle. In a case where data needs to travel to a cluster that is both south and west of the cluster 900, it can be more efficient to send the data directly to the south output port rather than to store the data in a register first, and then to send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster; any of the L2 directions—North, East, South, West; a switch register; one of the quad RAMs—data RAM, IRAM, or PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the clusters enter the configuration mode, various techniques, including direct memory access (DMA) can be used to load instructions from the kernel into instruction memories of the PEs. The clusters that were preprogrammed to enter configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can comprise an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

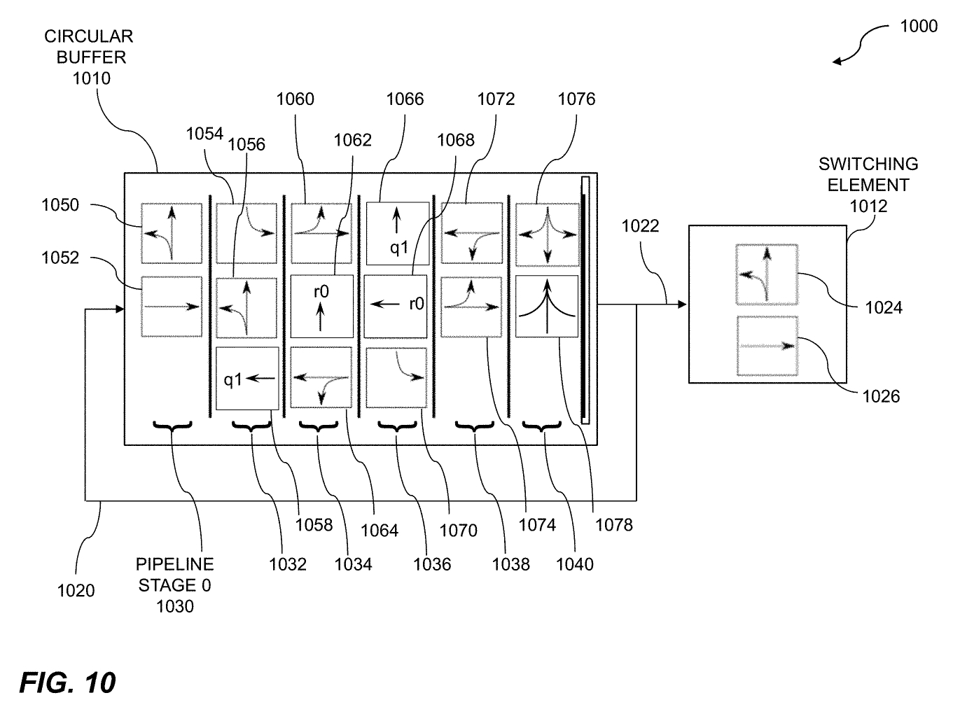

FIG. 10 shows a block diagram of a circular buffer. The circular buffer 1000 can include a switching element 1012 corresponding to the circular buffer. The circular buffer and the corresponding switching element can be used in part for data flow graph node update for machine learning. Using the circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the example 1000 shown, Pipeline Stage 0 1030 has an instruction depth of two instructions 1050 and 1052. Though the remaining pipeline stages 1-5 are not textually labeled in the FIG. 1000, the stages are indicated by callouts 1032, 1034, 1036, 1038, and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out on the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time-multiplexed.

In embodiments, the clusters implement multiple storage elements in the form of registers. In the example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. Hence, the instructions 1024 and 1026 in the switching element 1012 can also be transferred back to pipeline stage 0 as the instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1066. In the case of the instruction 1066, data from the processor q1 is moved to the north output. In some embodiments, if Xs have been placed into the processor q1, such as during the instruction 1058, then Xs would be retrieved from the processor q1 during the execution of the instruction 1066 and would be applied to the north output of the instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use preprocessing, such as by a compiler, to arrange the instructions in such a way that there are no collisions when the instructions are loaded into the circular buffer. Thus, the circular buffer 1010 can be statically scheduled in order to prevent data collisions. In embodiments, when the preprocessor detects a data collision, the scheduler changes the order of the instructions to prevent the collision. Alternatively, or additionally, the preprocessor can insert further instructions such as storage instructions (e.g. the instruction 1062), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that calculates the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

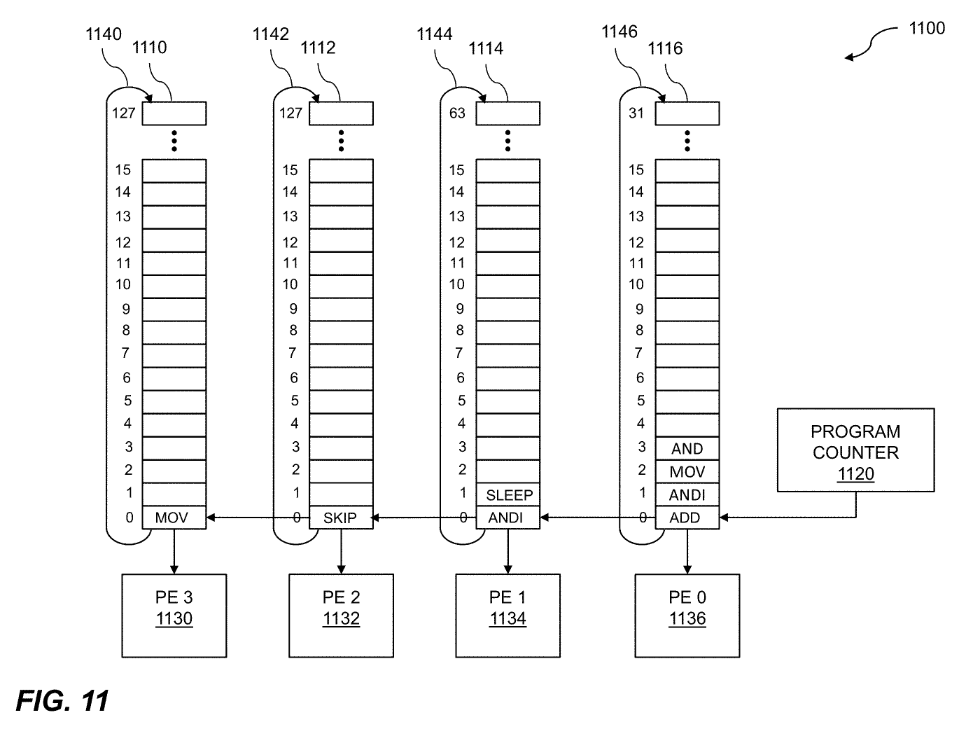

FIG. 11 illustrates circular buffers and processing elements. A diagram 1100 indicates example instruction execution for processing elements. The processing elements can include a portion of or all of the elements within a reconfigurable fabric. The instruction execution can include instructions for data flow graph node updates for machine learning. A circular buffer 1110 feeds a processing element 1130. A second circular buffer 1112 feeds another processing element 1132. A third circular buffer 1114 feeds another processing element 1134. A fourth circular buffer 1116 feeds another processing element 1136. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements, where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the first two circular buffers 1110 and 1112 have a length of 128 instructions, the third circular buffer 1114 has a length of 64 instructions, and the fourth circular buffer 1116 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, the first circular buffer 1110 contains a MOV instruction. The second circular buffer 1112 contains a SKIP instruction. The third circular buffer 1114 contains a SLEEP instruction and an ANDI instruction. The fourth circular buffer 1116 contains an AND instruction, a MOVE instruction, an ANDI instruction, and an ADD instruction. The operations performed by the processing elements 1130, 1132, 1134, and 1136 are dynamic and can change over time, based on the instructions loaded into the respective circular buffers. As the circular buffers rotate, new instructions can be executed by the respective processing element.

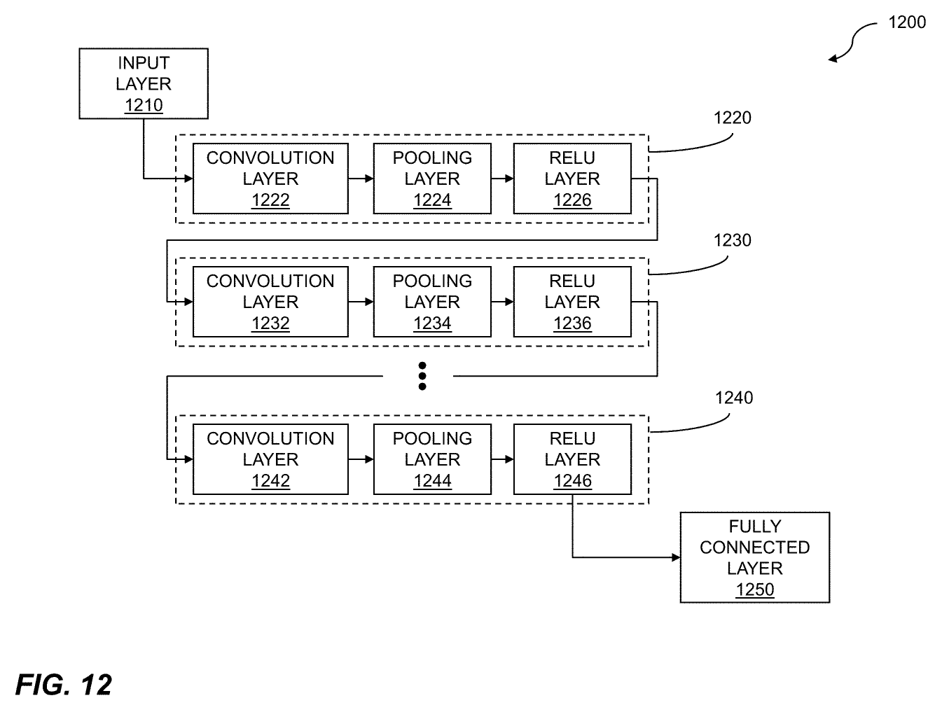

FIG. 12 shows a deep learning block diagram. The deep learning block diagram 1200 can include a neural network such as a deep neural network (DNN), a convolutional neural network (CNN), a recurrent neural network (RUN), and so on. A convolutional neural network can be based on layers, where the layers can include input layers, output layers, fully connected layers, convolution layers, pooling layers, rectified linear unit (ReLU) layers, bottleneck layers, and so on. The layers of the convolutional network can be implemented using a reconfigurable fabric. The reconfigurable fabric can include processing elements, switching elements, storage elements, etc. The reconfigurable fabric can be used to perform various operations such as logical operations. Deep learning can be applied to data flow graph node updates for machine learning.

A deep learning block diagram 1200 is shown. The block diagram can include various layers, where the layers can include an input layer, hidden layers, a fully connected layer, and so on. In some embodiments, the deep learning block diagram can include a classification layer. The input layer 1210 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 1200, which can represent a network such as a convolutional neural network, can contain a plurality of hidden layers. While three hidden layers, hidden layer 1220, hidden layer 1230, and hidden layer 1240 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1220 can include convolution layer 1222, pooling layer 1224, and ReLU layer 1226; layer 1230 can include convolution layer 1232, pooling layer 1234, and ReLU layer 1236; and layer 1240 can include convolution layer 1242, pooling layer 1244, and ReLU layer 1246. The convolution layers 1222, 1232, and 1242 can perform convolution operations; the pooling layers 1224, 1234, and 1244 can perform pooling operations, including max pooling, such as data down-sampling; and the ReLU layers 1226, 1236, and 1246 can perform rectification operations. A convolutional layer can reduce the amount of data feeding into a fully connected layer. The block diagram 1200 can include a fully connected layer 1250. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the cluster enters the configuration mode, various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

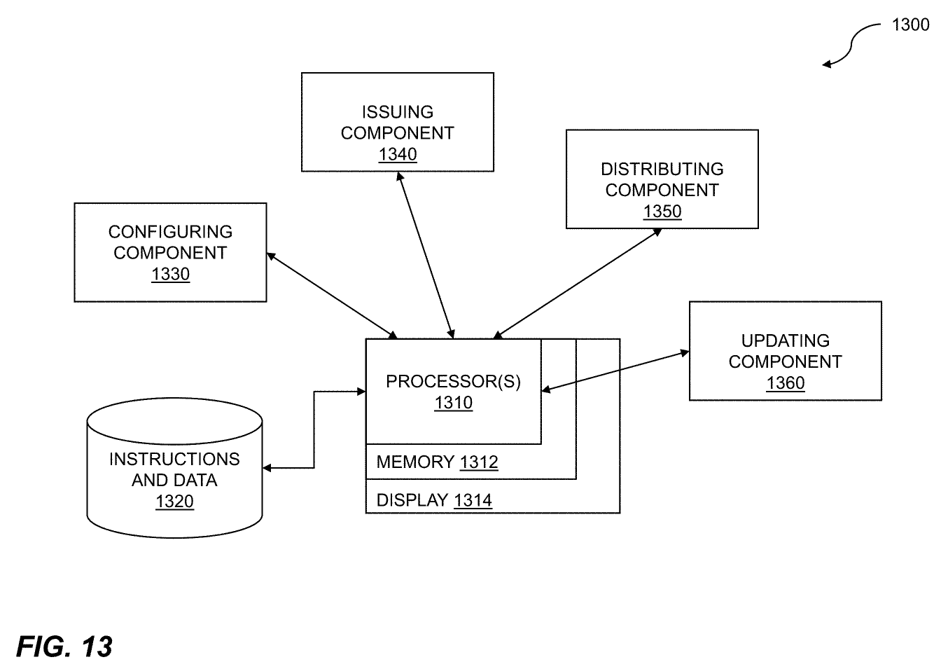

FIG. 13 is a system for a data flow graph update for machine learning. The system 1300 can include one or more processors 1310 coupled to a memory 1312 which stores instructions. The system 1300 can include a display 1314 coupled to the one or more processors 1310 for displaying data, intermediate steps, instructions, and so on. In embodiments, one or more processors 1310 are attached to the memory 1312 where the one or more processors, when executing the instructions which are stored, are configured to: configure a plurality of processing elements within a reconfigurable fabric to implement a data flow graph, wherein the nodes of the data flow graph include one or more variable nodes, and wherein the data flow graph implements a neural network; issue N copies of a variable contained in one of the one or more variable nodes, wherein the N copies are used for distribution within the data flow graph, and wherein N is an integer greater than or equal to 1 and less than or equal to the total number of nodes in the graph; distribute the N copies of a variable within the data flow graph; and update the neural network, based on the N copies of a variable.

The system 1300 can include a collection of instructions and data 1320. The instructions and data 1320 may be stored in a database, one or more statically linked libraries, one or more dynamically linked libraries, precompiled headers, source code, flow graphs, kernels, agents, or other suitable formats. The instructions can include instructions for data flow graph node update for machine learning. The data can include unstructured data, matrices, tensors, layers and weights, and so on that can be associated with a convolutional neural network, etc. The instructions can include a static schedule for controlling one or more rotating circular buffers. The system 1300 can include a configuring component 1330. The configuring component 1330 can include functions, instructions, or code for configuring a plurality of processing elements within a reconfigurable fabric to implement a data flow graph. The plurality of processing elements can include clusters of processing elements. The clusters on the reconfigurable fabric can include quads of elements such as processing elements. The reconfigurable fabric can further include other elements such as storage elements, switching elements, and the like.

The system 1300 can include an issuing component 1340. The issuing component 1340 can include functions and instructions for issuing N copies of a variable contained in one of the one or more variable nodes, where the variable nodes can include the variable nodes of the data flow graph. The N copies of the variable can be used for distribution within the data flow graph. The distribution can include sharing the copies of the variable with nodes of the data flow graph. The value N can be an integer which can be greater than or equal to 1 and can be less than or equal to the total number of nodes in the graph. The variable nodes and other nodes of the data flow graph can be assigned to processing elements of a reconfigurable fabric. The processing elements can be configured to perform logical operations such as Boolean operations, matrix operations, tensor operations, mathematical operations, and so on, where the logical operations are related to the data flow graph. In embodiments, the configuring and the issuing can be controlled by a session manager. The session manager can partition the data flow graph and can map the partitions to processing elements of the reconfigurable fabric.

The system 1300 can include a distributing component 1350. The distributing component 1350 can include functions and instructions for distributing the N copies of a variable within the data flow graph. The distributing within the data flow graph can include propagating the N copies to other nodes within the data flow graph. The propagating can include sending copies to nearest neighbor nodes within the data flow graph. The propagation can include sending copies to some of or all of the other nodes of the data flow graph. Non-variable nodes within the data flow graph can further distribute the N copies to still other nodes within the data flow graph. The system 1300 can include an updating component 1360. The updating component can include functions and instructions for updating the neural network, based on the N copies of a variable. The updating can include various techniques, where the techniques can include averaging, averaging after a number of iterations within the data flow graph, and so on. The averaging can include averaging the updates resulting from the distributing the N copies of a variable. The updating can be based on a running average of copies of the variable with the data flow graph. Other updating techniques can include averaging two or more sets of updates resulting from the distributing the two or more sets of N copies. The averaging two or more sets of updates can include parallel training of different data for machine learning.

The system 1300 can include a computer program product embodied in a non-transitory computer readable medium for data manipulation, the computer program product comprising code which causes one or more processors to perform operations of: configuring a plurality of processing elements within a reconfigurable fabric to implement a data flow graph, wherein the nodes of the data flow graph include one or more variable nodes, and wherein the data flow graph implements a neural network; issuing N copies of a variable contained in one of the one or more variable nodes, wherein the N copies are used for distribution within the data flow graph, and wherein N is an integer greater than or equal to 1 and less than or equal to the total number of nodes in the graph; distributing the N copies of a variable within the data flow graph; and updating the neural network, based on the N copies of a variable.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate, execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
configuring a plurality of processing elements within a reconfigurable fabric to implement a data flow graph, wherein nodes of the data flow graph include one or more variable nodes, and wherein the data flow graph implements a neural network;
issuing N copies of a variable contained in one of the one or more variable nodes, wherein the N copies are used for distribution within the data flow graph, and wherein N is an integer greater than or equal to 1;
distributing the N copies of a variable within the data flow graph; and
updating the neural network, based on the N copies of a variable.

2. The method of claim 1 wherein the issuing N copies occurs before the one or more variable nodes are paused for updating.

3. The method of claim 1 wherein the distributing within the data flow graph includes propagating the N copies to other nodes within the data flow graph.

4. The method of claim 3 wherein the other nodes include non-variable nodes.

5. The method of claim 4 wherein the non-variable nodes further distribute the N copies to still other nodes within the data flow graph.

6. The method of claim 1 wherein N is less than or equal to a total number of nodes in the graph.

7. The method of claim 1 further comprising averaging updates resulting from the distributing the N copies of a variable.

8. The method of claim 7 further comprising training the neural network, based on the averaging.

9. The method of claim 8 wherein the training comprises distributed neural network training.

10. The method of claim 1 further comprising updating based on a running average of copies of the variable within the data flow graph.

11. The method of claim 1 wherein the variable nodes contain weights for deep learning.

12. The method of claim 1 wherein the data flow graph comprises machine learning or deep learning.

13. The method of claim 1 wherein the configuring is controlled by a session manager.

14. The method of claim 1 further comprising pausing the data flow graph.

15. The method of claim 14 wherein the pausing is accomplished by loading invalid data.

16. The method of claim 15 wherein the pausing is controlled by an execution manager.

17. The method of claim 14 wherein the pausing is accomplished by withholding new data from entering the data flow graph.

18. The method of claim 17 wherein the pausing is controlled by an execution manager.

19. The method of claim 1 further comprising issuing two or more sets of N copies of the variable for distribution within the data flow graph.

20. The method of claim 19 further comprising averaging two or more sets of updates resulting from the distributing the two or more sets of N copies.

21. The method of claim 20 wherein the averaging two or more sets of updates comprises parallel training of different data for machine learning.

22. The method of claim 1 wherein the processing elements are controlled by circular buffers.

23. (canceled)

24. The method of claim 1 wherein data flow graph is used to train a neural network.

25-26. (canceled)

27. A computer program product embodied in a non-transitory computer readable medium for data manipulation, the computer program product comprising code which causes one or more processors to perform operations of:
configuring a plurality of processing elements within a reconfigurable fabric to implement a data flow graph, wherein nodes of the data flow graph include one or more variable nodes, and wherein the data flow graph implements a neural network;
issuing N copies of a variable contained in one of the one or more variable nodes, wherein the N copies are used for distribution within the data flow graph, and wherein N is an integer greater than or equal to 1;
distributing the N copies of a variable within the data flow graph; and
updating the neural network, based on the N copies of a variable.

28. A computer system for data manipulation comprising:
a memory which stores instructions;
one or more processors attached to the memory wherein the one or more processors, when executing the instructions which are stored, are configured to:
configure a plurality of processing elements within a reconfigurable fabric to implement a data flow graph, wherein nodes of the data flow graph include one or more variable nodes, and wherein the data flow graph implements a neural network;
issue N copies of a variable contained in one of the one or more variable nodes, wherein the N copies are used for distribution within the data flow graph, and wherein N is an integer greater than or equal to 1;
distribute the N copies of a variable within the data flow graph; and
update the neural network, based on the N copies of a variable.
